(19) United States
(12) Patent Application Publication
(10) Pub. No.: US 2010/0272316 A1
(43) Pub. Date: Oct. 28, 2010

(54) Controlling An Associated Device

(76) Inventors: Bahir Tayob, Plano, TX (US); Bryan Shnider, Richardson, TX (US); Ali Shams, Dallas, TX (US)

Correspondence Address: Houda El-Jarrah, 3121 Buffalo Speedway Apt 4303, Houston, TX, 77098, US

(21) Appl. No.: 12/799,086

(22) Filed: Apr. 16, 2010

Related U.S. Application Data
(60) Provisional application No. 61/171,815, filed on Apr. 22, 2009.

(51) Int. Cl. G06K 9/62

(52) U.S. Cl. 382/103

(57) ABSTRACT

In an illustrative embodiment a computer-implemented process for controlling an associated device utilizing an automated location tracking and control system to produce an action associates a target with a blind node having a wireless transmitter, wherein the target moves within a predetermined area among a set of reference nodes. The computer-implemented process performs a continuous data acquisition based on a target movement data, wherein the continuous data acquisition is repeated within a predetermined interval, performs a continuous calculation of a target location using the target movement to form target location vectors, wherein the continuous calculation is repeated within the predetermined interval, performs a transmission of current coordinate information using the target location vectors, and transforms received current coordinate information into a device control code, wherein the device control code is a set of voltages. The computer-implemented process transmits the device control code to an associated device, and responsive to the device control code, controls an action on the associated device in real time, wherein the action is directed to the tracked object.

### BACKGROUND

1. Field of the Illustrative Embodiments

The disclosure relates generally to a data processing system for tracking an object, and more specifically, to a process and apparatus for an automated location tracking and control system.

2. Description of the Related Art

Many situations arise in which multiple human operators are needed to perform a series of actions using associated devices. For example, an associated device in the form of a light source may be used to direct an output of light onto an object. A follow spot is an example of such a light source and is more commonly referred to as a spotlight. The spotlight is associated with the target object and may be referred to as an associated device. Human operators are required to manipulate spotlights to follow objects moving on a stage, even when the operators are in hard to reach areas of a theater, such as an overhead catwalk.

For video cameras, a similar situation occurs when a human user, or operator, operates the video camera to track an object, for example, a person for recording a video of transpiring events involving the person. A number of human users required to produce various actions of the video camera operator may be reduced using automation to replicate the decision-making skills of a human operator.

Current technology provides varying advancements using wireless technology and local area networks. Wireless technology may be provided over varying distances using radio signals to transfer data previously transferred through a physical connection. With regard to the spotlights and video cameras previously mentioned, current technology and solutions do not include an adequate tracking and control system coupled to an associated device, such as the spotlight or the video camera, to provide a desired function from the associated devices.

### SUMMARY

According to one illustrative embodiment, a process for controlling an associated device utilizing an automated location tracking and control system to produce an action associates a target with a blind node having a wireless transmitter, wherein the target moves within a predetermined area among a set of reference nodes. The computer-implemented process performs a continuous data acquisition based on a target movement data, wherein the continuous data acquisition is repeated within a predetermined interval, performs a continuous calculation of a target location using the target movement to form target location vectors, wherein the continuous calculation is repeated within the predetermined interval, performs a transmission of current coordinate information using the target location vectors, and transforms received current coordinate information into a device control code, wherein the device control code is a set of voltages. The computer-implemented process transmits the device control code to an associated device, and responsive to the device control code, controls an action on the associated device in real time, wherein the action is directed to the tracked object.

According to another illustrative embodiment a computer program product for an automated location tracking and control system is presented. The computer product comprises a computer recordable-type media containing computer executable program code stored thereon, the computer executable program code comprising computer executable program code for associating a target with a blind node having a wireless transmitter, wherein the target moves within a predetermined area among a set of reference nodes, computer executable program code for performing a continuous data acquisition based on a target movement data, wherein the continuous data acquisition is repeated within a predetermined interval, computer executable program code for performing a continuous calculation of a target location using the target movement to form target location vectors, wherein the continuous calculation is repeated within the predetermined interval, computer executable program code for performing a transmission of current coordinate information using the target location vectors, computer executable program code for transforming received current coordinate information into a device control code, wherein the device control code is a set of voltages, computer executable program code for transmitting the device control code to an associated device, and computer executable program code responsive to the device control code, for controlling an action on the associated device in real time, wherein the action is directed to the tracked object.

According to another illustrative embodiment, an apparatus for an automated location tracking and control system is presented. The apparatus comprises a communications fabric, a communications unit connected to the communications fabric, an input/output unit connected to the communications fabric, a display connected to the communications fabric, a memory connected to the communications fabric, wherein the memory contains computer executable program code stored therein, and a processor unit connected to the communications fabric. The processor unit executes the computer executable program code to direct the apparatus to associate a target with a blind node having a wireless transmitter, wherein the target moves within a predetermined area among a set of reference nodes, perform a continuous data acquisition based on a target movement data, wherein the continuous data acquisition is repeated within a predetermined interval, perform a continuous calculation of a target location using the target movement to form target location vectors, wherein the continuous calculation is repeated within the predetermined interval, perform a transmission of current coordinate information using the target location vectors, transform received current coordinate information into a device control code, wherein the device control code is a set of voltages, transmit the device control code to an associated device, and responsive to the device control code, control an action on the associated device in real time, wherein the action is directed to the tracked object.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a pictorial representation of a network of data processing systems in which illustrative embodiments of the disclosure may be implemented;

FIG. 2 is a block diagram of a data processing system in which illustrative embodiments of the disclosure may be implemented;

FIG. 3 is a block diagram of components of an automated tracking and control system for controlling an associated device in accordance with an illustrative embodiment of the disclosure;

FIG. 4 is a block diagram of possible arrangements of reference nodes and blind nodes used within the automated location tracking and control system of FIG. 3, in accordance with an illustrative embodiment of the disclosure;

FIG. 5 is a flowchart of an overview of a process using the automated location tracking and control system of FIG. 3 in accordance with illustrative embodiments of the disclosure;

FIG. 6 is a flowchart of a detailed process using the automated location tracking and control system of FIG. 3 in accordance with illustrative embodiments of the disclosure;

FIG. 7 is a flowchart of a process, used within the process of FIG. 6, for determining a current location of a blind node in accordance with illustrative embodiments of the disclosure.

### DETAILED DESCRIPTION

As will be appreciated by one skilled in the art, the illustrative embodiments may be embodied as a system, method or computer program product. Accordingly, the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the illustrative embodiments may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including but not limited to wireless, wire line, optical fiber cable, RF, etc.

Computer program code for carrying out operations of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments is described below with reference to flowchart illustrations and/or block diagrams of methods, apparatus (systems) and computer program products according to embodiments of the illustrative embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing, apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium-produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

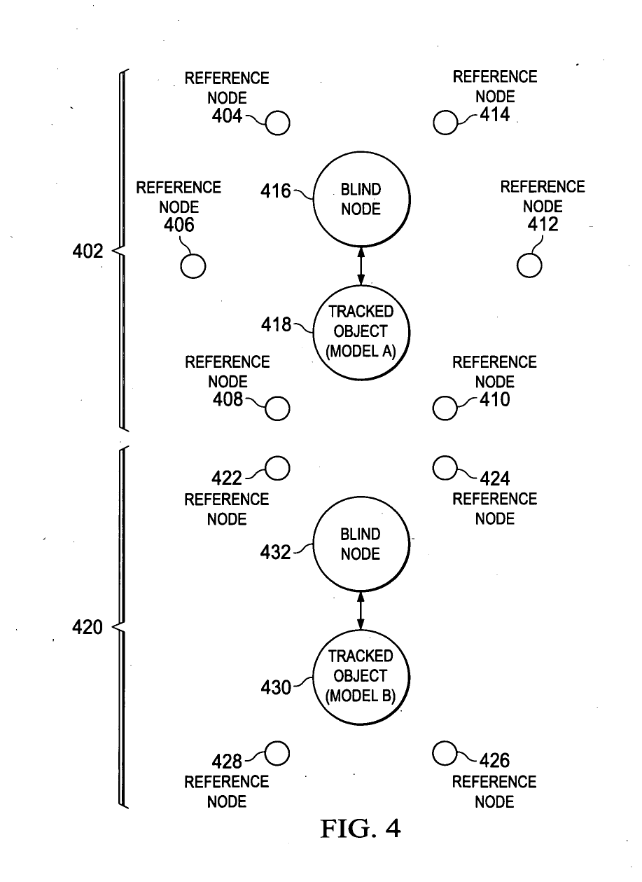

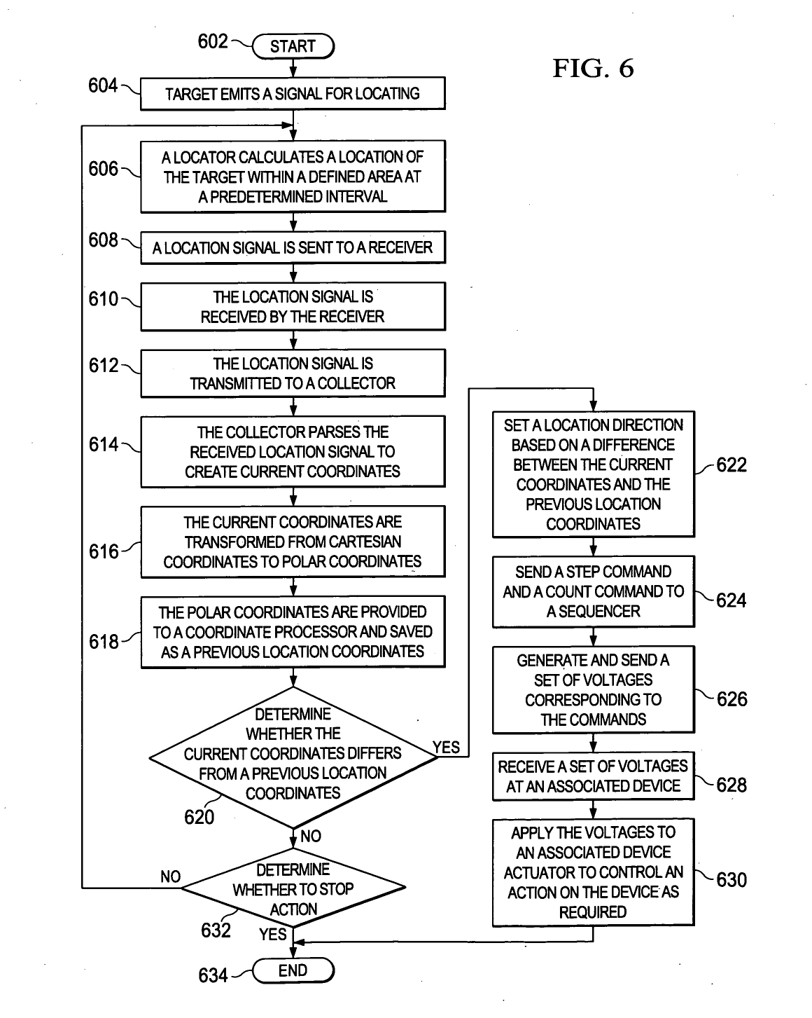

In one embodiment, an other programmable apparatus besides a computer may be used to replicate the functions/acts specified for data processing system 430 in FIG. 4 and data processing system 630 in FIG. 6.

Network data processing system 100 is a network of computers in which different illustrative embodiments may be implemented. Network data processing system 100 contains network 102, which is the medium used to provide communications links between various devices and computers connected within network data processing system 100. Network 102 may include permanent or temporary connections, and wireless or land line connections. Network 102 may be utilized as a wireless network set to a pre-defined wireless standard that may transmit wireless signals 420 in FIG. 4 or wireless signals 620 in FIG. 6.

In the depicted example, servers 104 and 106 are connected to network 102, along with storage unit 108. In addition, clients 110, 112 and 114 are also connected to network 102. These clients, 110, 112 and 114, may be, for example, personal computers or network computers. Clients 110, 112, and 114 may be implemented as data processing system 430 in FIG. 4 and data processing system 630 in FIG. 6. Control board software 452 and location software 432 in FIG. 4 and control board software 652 and location software 632 in FIG. 6 may be installed and utilized on clients 110, 112, and 114.

In the depicted example, server 104 provides data, such as boot files, operating system images and applications, to clients 110, 112 and 114. Clients 110, 112 and 114 are clients to server 104 and 106. Network data processing system 100 may include additional servers, clients, and other devices not shown.

In the depicted example, networked data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, network data processing system 100 also may be implemented as a number of different types of networks such as, for example, an Intranet or a local area network.

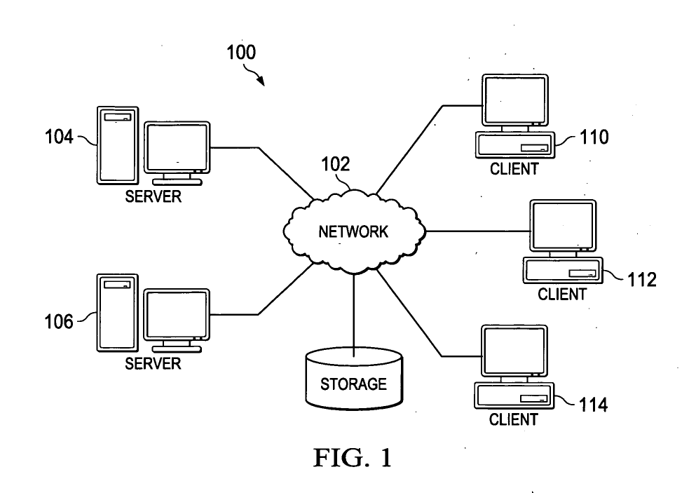

FIG. 1 is intended as an example and not as an architectural limitation for the processes of the different illustrative embodiments.

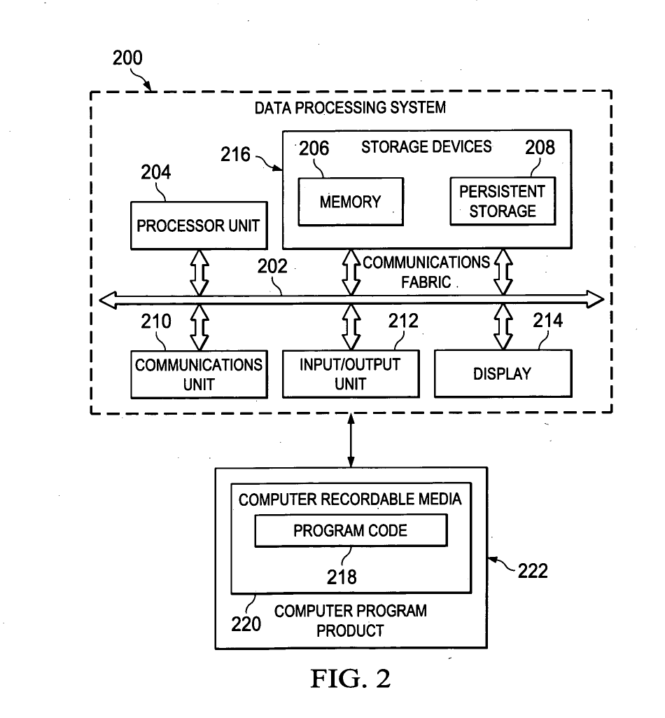

Turning now to FIG. 2, a diagram of a data processing system is depicted in accordance with an illustrative embodiment. In one illustrative embodiment, data processing system 430 in FIG. 4 and data processing system 630 in FIG. 6 may comprise, without limitation, the listed components in FIG. 2.

In this illustrative example, data processing system 200 includes communications fabric 202, which provides communications between processor unit 204, memory 206, persistent storage 208, communications unit 210; input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instruction are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Accordingly, illustrative embodiments provide examples of a process and an apparatus for an automated location tracking and control system. For example, processor unit 204 executes computer executable program code to associate a target with a blind node having a wireless transmitter, wherein the target moves within a predetermined area among a set of reference nodes. The computer executable program code may be stored in storage devices 216 or a memory 206. Processor unit 204 performs a continuous data acquisition based on a target movement data, wherein the continuous data acquisition is repeated within a predetermined interval, performs a continuous calculation of a target location using the target movement to form target location vectors, wherein the continuous calculation is repeated within the predetermined interval, performs a transmission of current coordinate information through communications unit 210 using the target location vectors, and transforms received current coordinate information into a device control code, wherein the device control code is a set of voltages. The computer-implemented process transmits the device control code through communications unit 210 to an associated device, and responsive to the device control code, controls an action on the associated device in real time, wherein the action is directed to the tracked object. Data acquired may be stored in memory 206 or persistent storage 208 for subsequent processing. Further a user interface may be provided using display 214 for control of the process.

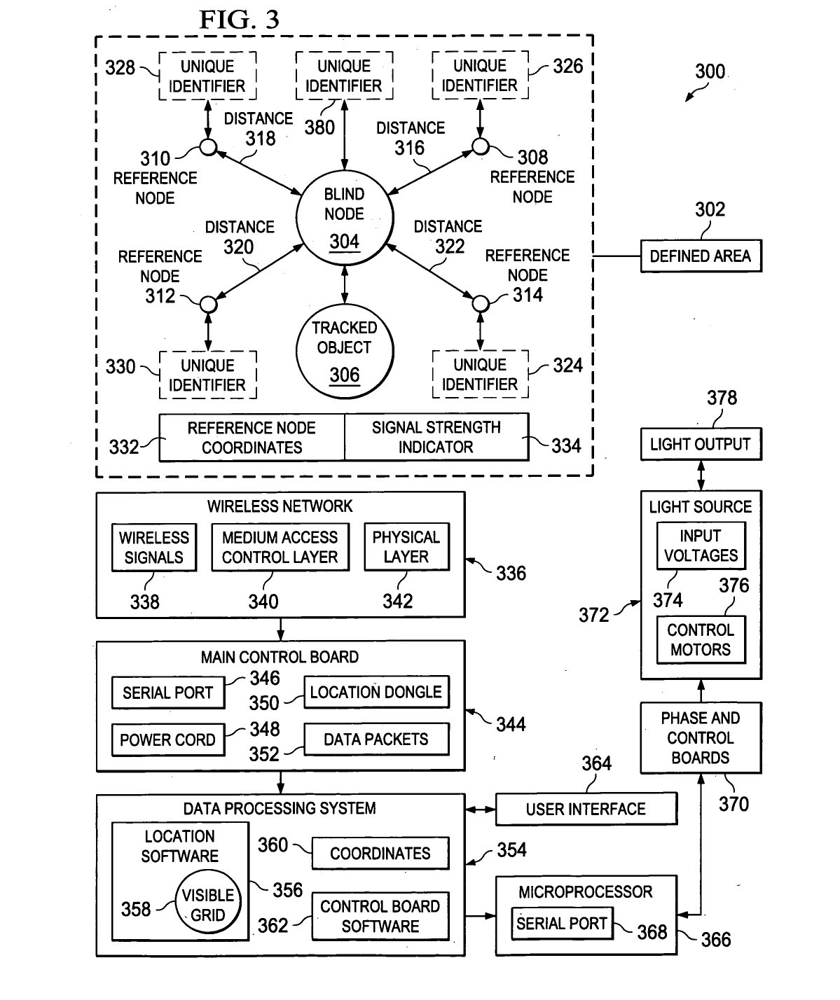

With reference to FIG. 3, a block diagram of components of an automated location tracking and control system for controlling an associated device in accordance with an illustrative embodiment of the disclosure is presented. Location tracking and control system 300 is an example of system implemented using data processing system 200 of FIG. 2 within an environment of data processing system 100 of FIG. 1.

Location tracking and control system 300 comprises blind node 304. The term “blind node”, as used herein, refers to a node or an end device associated with a moveable object, such as tracked object 306. In the illustrative embodiments, blind node 304 is coupled to tracked object 306. Blind node 304 is available in a multitude of sizes and shapes. However, the size of the nodes, both the reference nodes and the blind node, are generally very small. Currently, most nodes are smaller than the palm of one's hand. However, the node sizes may be varied to be as large as required by a system. Further, a plurality of blind nodes may be used. A plurality of blind nodes, such as blind node 304, may be coupled to the same tracked object, such as tracked object 306, or to multiple tracked objects. Thus, the illustrative embodiments are not limited to utilizing a single blind node with a single tracked object.

Blind node 304 may be coupled through various means to tracked object 306 including without limitation, permanent and non-permanent attachment to the moveable tracked object. These means may include mounting blind node 304 on another object that is carried on a person, or in the hands of a person. Further, blind node 304 may be attached to the surface of the moveable tracked object in a removable manner. Removable means of attachment includes fasteners of all shapes, and forms that may use buttons, clips, and relevant elements for tying the blind node to the moveable tracked object. To further clarify, blind node 304 may be located on various objects that a person may attach to their body, including, but not limited to, earphones, ties, bracelets, belts, or jewelry. Blind node 304 does not have to be visible, on the moveable tracked object, to others. Blind node 304 may be concealed so as not to be visible to others.

Blind node 304 may be coupled to the person so as not to restrict movement in multiple directions. Blind node 304 may include an antenna for transmitting signals to the listed set of reference nodes and to main control board 344. In one embodiment, main control board 344 in conjunction with control board software 362 programs blind node 304.

Tracked object 306 may be either inanimate or animate. Tracked object 306 may be a person. A person acting as a moveable object is expected to move in multiple directions for an event. Blind node 304 is coupled to tracked objected 306 so as to transmit the position of tracked object 306 to location dongle 350 on main control board 344. The position of tracked object 306 is in turn transmitted to an associated device of light source 372 so that light output 378 may be produced in the direction of the current location of tracked object 306.

Associated device of light source 372 is any type of device that may produce an action, such as an action of light output 378. Action of light output 378 produces a result relevant to the current location of tracked object 306. Action of light output 378 may be a result of a feature or function of associated device of light source 372. It should be noted that an associated device is not limited to a light source producing device. Thus, the illustrative embodiments may be used so that various functions of the associated device may be caused to be activated and aimed in the direction of tracked object 306. An associated device may include, but is not limited to, a light source, a video camera that records both, audio and video, a thermal device, an infrared device, a camera without video recording capabilities, and an audio recording that does not include visual recording capabilities. An associated device is capable of producing an action. The action is the output that may be produced in place of light output 378. Depending on the associated device, light output 378 may be replaced with, without limitation by the following examples, an audio output, a video recording output, a camera output, or a combination of several such actions.

There is still a pressing need for automated systems that allow associated devices, such as associated device of light source 372, to track certain objects, such as tracked object 306, coupled with the ability to direct the associated device to produce an action. Often time, human users are required to initiate an act from a device in situations that may involve risk to the human user, such as in the case, where a human user is required to direct a light source in a theater to follow a tracked object by standing on small and elevated platform. Using the illustrative embodiments, a human user is not required to stand on the high and elevated platform to produce an action, i.e. a light output, from the light source. Instead, the illustrative embodiments disclose an automated system whereby an object's movements are continuously monitored and an associated device is manipulated utilizing the machines and processes disclosed herein to produce an action in the direction of the desired object. Many cases exists in which replacing a human user to produce an action on an associated device would be more advantageous and efficient to an entity or organization or user of the associated device.

In the above mentioned examples, each associated device is capable of producing an action. For example, a light source produces light. An audio recording device that does not include visual recording capabilities records audio. A video camera records audio and video content. A camera without video recording capabilities takes still motion pictures. The illustrative embodiments are not specifically limited to these examples of associated devices or the resulting actions. However, illustrative embodiments may include these associated devices and the resulting actions in conjunction with the illustrated automated tracking system.

In this example, action of light output 378 is directed towards tracked object 306. The illustrative embodiments are utilized to direct light output 378 to the most current location of tracked object 306. Action of light source 372 is produced in real time to interact in some manner with tracked object 306. The term “real time”, as used herein, refers to an almost simultaneous occurrence of action of light source 372 with the movements of tracked object 306. In other words, there is almost no perceived delay in the interaction of action of light source 372 and tracked object 306. In one embodiment, when the movement of tracked object 306 is within defined area 302, associated device of light source 372 is able to produce an action of light output 378 in the direction of tracked object 306. However, some delay is expected in the system due to the delays involved in automated location tracking and control system 300 and the time needed to transfer the position of tracked object 306 to associated device of light source 372.

Associated device of light source 372 may include any optical devices, audiovisual devices, or purely audio devices. Optical devices either processes light waves to enhance an image for viewing, or analyze light waves (or photons) to determine one of a number of characteristic properties. Optical devices include, without limitation, binoculars, cameras, video cameras, microscopes, and telescopes. Audiovisual devices may refer to devices configured to function with both a sound and a visual component, including, without limitation, televisions, tape recorders, compact disc players, compact disk recorders, digital music recorders, and video cameras. Accordingly, the action of light output 378 is an output or a result of associated device of light source 372.

The associated device of light source 372 is configured to perform either a single function or a plurality of functions. For example, when a light source, such as light source 372, without limitation, is utilized as an associated device of light source 372, a primary function of the light source is to produce an output of light and direct the light to shine on tracked object 306. If associated device of light source 372 is an audiovisual device, such as a video camera, one of the functions of a video camera is to record and playback events stored on a storage medium. In an embodiment, a plurality of associated devices may be coupled to multiple blind nodes and multiple tracked objects. In another embodiment, a plurality of associated devices may be coupled to produce a variety of actions towards a single tracked object. For example, a need may arise for both a light source and a video camera to be directed to the same tracked object, such as tracked object 306. Thus, one associated device may comprise a light source coupled to blind node 304 on tracked object 306. Additionally, another associate device may comprise a video camera that is also coupled to blind node 304 on tracked object 306. Thus, a plurality of associated devices may be configured to tracked object 306 using blind node 304.

Tracked object 306 is capable of moving in all three planes. Tracked object 306 may be moved horizontally, vertically, or along a diagonal direction for depth. Tracked object 306 may thus move in all three dimensions of a space. Blind node 304 may be moved through the volition and power of the moveable object on its own. Blind node 304 may also be manipulated through other automatic means, such as remote control, wireless, or manual manipulation. Tracked object 306 may be inanimate. Tracked object 306 may be a human person. Tracked object 306 may further include animals, vegetation, or other living objects.

Location tracking and control system 300 further includes a set of reference nodes, such as reference node 308, reference node 310, reference node 312, and reference node 314. A reference node, as used herein, is a node or an end device that is located at a static location. Each reference node has a fixed position within defined area 302. A reference node in location tracking and control system 300 may be fixed to any surface using any permanent or non-permanent means for fixing the reference node to the surface. Reference nodes and blind nodes may be battery operated to provide power, or may utilize, any other non-battery source for power.

In an embodiment, a reference node is configured to receive requests for information about the location of the reference node. A reference node, such as reference nodes 308, 310, 312, and 314, transmits requested reference node location information back to blind node 304.

Blind node 304 functions as a device that transmits requests for location information from reference nodes. Further, blind node 304 calculates the position of the blind node using reference node location information received at blind node 304. Each node may be used interchangeably depending on whether the node is configured to receive location information or to transmit a request for location information. Thus, in another embodiment, blind node 304 may be made to serve as a reference node. Blind node 304 and reference nodes 308, 310, 312, and 314 include the same hardware to function as either a blind node or a reference node.

Reference nodes 308, 310, 312, and 314 are located at a threshold distance or predetermined distance from each other and blind node 304 so as to be able to transmit signals to one another and to blind node 304. The predetermined distance refers to a certain distance within which signals may be transmitted and received. A predetermined distance depends on the technological capabilities of the hardware used for reference nodes 308, 310, 312, and 314, as well as the technological capabilities of main control board 344. When a distance between blind node 304 and reference node 308 exceeds a threshold of a predetermined distance, then reference node 308 will be unable to communicate its location position to blind node 304.

A threshold distance or predetermined distance will vary as further progress is made with an ability of a reference node to transmit signals at greater distances from one another. Further, reference nodes, such as reference nodes 308, 310, 312, and 314 and blind nodes, such as blind node 304, may be supplied with an amplifying device to amplify a signal even if a threshold distance is approached.

A plurality of reference nodes is used in location tracking and control system 300. In another embodiment, a single reference node may be utilized, up to an unlimited number of reference nodes. In another embodiment, technology may allow blind node 304 to dynamically adjust to become a reference node and for a reference node to become a blind node, such as blind node 304. In other words, future technology may adjust the current specification of a reference node as being fixed and a blind node as being non-fixed to a position.

Reference nodes 308, 310, 312, and 314 are associated with unique identifiers 326, 328, 330 and 324. Blind node 304 is also associated with unique identifier 380. Unique identifiers 326, 328, 330, 324 and 380 are also the medium access control (MAC) addresses of each nodal device. The medium access control (MAC) address of each device is included in the hardware of each nodal device. Control board software 362 is used to assign the medium access control (MAC) address.

In one embodiment, the medium access control (MAC) address may be a hexadecimal (hex) string that may be configured using control board software 362. A hex string refers to a hexadecimal numbering system of 16 characters. A hex string is used as a form of programming shorthand that includes ten digits and six letters. Main control board 344 is programmed using control board software 362 to assign the listed set of unique identifiers for the set of reference nodes and blind node. In another embodiment, a unique identifier may be a value used to identify a device on a network, including reference nodes and a blind node.

Wireless network 336 may implement the layered stack for communication between devices and over a wireless network. In one embodiment, wireless network 336 includes physical layer 342 and medium access control layer 340. In one embodiment, wireless network 336 is implemented utilizing devices configured to comply with the certification standard set for IEEE 802.15.4. However, wireless network 336 may be configured to comply with other wireless network standards.

Many wireless networks operate based on a set of standards developed by the Institute of Electrical and Electronics Engineers also known as the IEEE. This group is responsible for developing and maintaining standards for networks, including both wired and wireless. The term “wireless” as used herein, which means without wires. Data may be transferred over wireless networks. Wireless networks include wireless personal area networks (WPAN). WPANs are wireless networks for intercommunicating devices.

IEEE 802.15.4 318 is an identifier for a standard developed by the IEEE for a specific low rate wireless personal area network. IEEE 802.15.4 318 is also the standard applied to networks and devices that comply with the “Zigbee™ certification.” Zigbee is a wireless network technology capable of short range, low power, and low cost. The illustrative models herein may, but are not limited to, utilizing devices configured to the Zigbee specification. The Zigbee network structure comprises a physical layer, a medium access control layer, a network layer, a Zigbee application layer, and a security layer. The IEEE 802.15.4 standard group regulates definition of the layers of the network specification. The layers above the network layer are further defined by the Zigbee alliance. A variety of models from different manufactures may be implemented if the models meet the Zigbee certification. However, in future scenarios, other models and devices may be utilized even if they do not meet the Zigbee certification. Implementation of the Zigbee specifications provides a location engine for determining a location of a target object with respect to a location of reference nodes. The locating technique provides a capability to determine a position of an object as the object moves relative to locations of reference nodes within a set of reference nodes.

Wireless network 336 is a layered implementation including medium access control (MAC) layer 340 and physical layer 342 as layers 2 and 1 respectively. In one embodiment, unique identifiers are assigned to all reference nodes and all blind nodes used for the automated tracking system. The unique identifiers are also the medium access control (MAC) addresses. These MAC addresses are included on the hardware of each node. The assigned unique identifiers 324, 326, 328, 330, and 372 for the listed set of reference nodes 308, 310, 312, 314 and blind node 304 are also medium access control (MAC) addresses for each respective node.

A medium access control (MAC) layer is a layer of a distributed communications system that is concerned with the control of access to a medium that is shared between two or more entities. Communication devices, including computers, access medium access control (MAC) layer 340 using their own unique medium access control addresses. The medium access control addresses are hardware addresses of a device designed for connection to a shared network medium. A medium access control address is a unique address and does not change. Part of the advantage of a medium access control address is that the address is location independent, meaning the medium access control address stays with the device it is associated with from the beginning. This is in contrast to network layer addresses that are not location independent.

The upper layers of wireless network 336 are comprised of application profiles layer, applications framework layer, and network and security layers. These upper layers may be customized to accommodate a variety of applications and security set ups for any systems utilizing an automated location tracking and control system to produce an action on an associated device. Application profiles layer and applications framework layer may include software used to configure communication devices in wireless network 336. For example, and without limitation, location software 356 and control board software 362 may be configured to operate on application profiles layer and applications framework layer.

Wireless network 336 may be configured to transmit data using wireless signals 338 within a specific range of frequency bands. Wireless network 336 may be utilized over a variety of frequency bands, including, but not limited, to ultra high frequency (UHF) bands or very high frequency (VHF) bands. Ultra high frequency (UHF) designates a range with a short antenna band of electromagnetic waves with frequencies between 300 MHz and 3 GHz (3,000 MHz). Very high frequency (VHF) applies to lower frequency signals or lower bands. Wireless network 336 may be utilized over any of these frequency bands. Super high frequency may be utilized as well in one embodiment.

In one embodiment, a low rate wireless personal area network is utilized because the low data rate usually provides a longer battery life and lower complexity. As previously mentioned, the listed set of reference nodes 308, 310, 312 and 314 are battery operated. Blind node 304 is also battery operated. Functioning over a wireless standard such as IEEE 802.15.4 assists to reduce costs associated with the technology and battery life of the nodes. Compared to Bluetooth™, which operates at IEEE standard 802.15.1, the technology utilizing 802.15.4 is considered less expensive to design and to utilize. However, wireless network 336 may be configured to Bluetooth standards as well as accompanying adjustments for all hardware devices to communicate and transmit signals.

Global positioning systems may be utilized as well, however, disadvantages exist with using global positioning systems. Global positioning systems (GPS) generally tend to include greater delays and are less precise at pinpointing positions of objects, such as tracked object 306, than wireless personal area networks. Global positioning systems rely on a number of orbiting satellite systems that provide positional information regarding both the longitude, and latitude, of an object. Global positioning systems transmit radio waves on a certain frequency. Calculations for positioning may be performed using a triangulation method.

However, global positioning systems generally do not pinpoint an exact location. GPS comes within a range of a location of a tracked object, such as tracked object 306. In using the automated tracking system, a more precise technology may be desired to pin point the location of tracked object 306 in a more accurate fashion. Further, GPS signals may have more interference and difficulty in transmitting to devices than wireless networks. GPS signals, for example, often cannot transmit when an environment includes many barriers, such as thick walls or is located very deep below the earth. Wireless networks, on the other hand, may be utilized in these scenarios with minimal time delays and with greater precision. However, the illustrative embodiments do not exclude utilizing GPS systems to locate tracked object 306 in accordance with some aspects of the illustrative embodiments.

Main control board 344 is a control board for managing reference nodes, blind nodes, and receiving transmitted information from reference nodes and blind nodes. Main control board 344 also functions to transmit data packets 352 to and from data processing system 354. Main control board 344 utilizes control board software 362 to manage the reference nodes and blind nodes. Main control board 344 may be externally located to data processing system 354, thus requiring coupling to data processing system 354 in one embodiment. In one embodiment, main control board 344 is coupled to data processing system 354 through serial port 346. Universal serial bus (USB) type serial port is a serial bus standard to connect devices, such as main control board 344, to a host computer or data processing system, such as data processing system 354.

Main control board 344 may receive power for function from a battery source. Main control board 344 may also receive power from any type of non-battery source. In this embodiment, main control board 344 includes power cord 348 for receiving power from one example of a non-battery source.

Main control board 344 transmits data packets 352 to data processing system 354 into location software 356. Data packets 352 may be data received from reference nodes and blind nodes. Data packets 352 may include position coordinates of blind nodes and reference nodes.

In one embodiment, control board software 362 is provided to a user from a manufacturer of main control board 344. Further, in the same embodiment, the listed set of reference nodes, blind node 304, main control board 344, and control board software 362 are all included as a kit to function together. However, illustrative embodiments are not limited to a kit including all of these items together. In other embodiments, the set of reference nodes, blind nodes, main control board, and main control board software may be purchased separately. In these other embodiments, the mentioned items may be programmed to operate together as a positioning system. Control board software 362 is also used to define a specific area, such as defined area 302, within which blind node 304 will travel. Control board software 362 is used to determine the static coordinates on a defined grid for the listed reference nodes.

A coordinate is a number that determines the location of a point along a line or a curve. A list of two, three or more coordinates may be used to determine the location of a point on a surface, volume, or other higher-dimensional domain. The defined area that includes the coordinates may be divided into an area using Cartesian Coordinates. Cartesian Coordinates are part of the Cartesian coordinate system, which is also known as the rectangular coordinate system. The Cartesian coordinate system is used to determine each point uniquely in a plane through two numbers, usually called the x-coordinate or abscissa, and the y-coordinate or ordinate of the point. To define the coordinates, two perpendicular directed lines (the x-axis and the y-axis), are specified, as well as the unit length, which is marked off on the two axes. Cartesian coordinate systems are also used in space (where three coordinates are used) and in higher dimensions. Polar coordinates may also be used in another embodiment for defined area 302. Other coordinate categorizations may also be used, including without limitation, orthogonal coordinates, two dimensional orthogonal coordinate systems, a parabolic coordinate system, bipolar coordinates, hyperbolic coordinates, elliptic coordinates, three dimensional orthogonal coordinate systems, a cylindrical coordinate system, a spherical coordinate system, a parabolic coordinate system, parabolic cylindrical coordinates, paraboloidal coordinates, oblate spheroidal coordinates, prolate spheroidal coordinates, ellipsoidal coordinates, elliptic cylindrical coordinates, toroidal coordinates, bispherical coordinates, bipolar cylindrical coordinates, conical coordinates, flat-ring cyclide coordinates, flat-disk cyclide coordinates, bi-cyclide coordinates, cap-cyclide coordinates, curvilinear coordinates, circular coordinate system, cylindrical coordinate system, plücker coordinates, generalized coordinates, canonical coordinates, parallel coordinates, and whewell equation relates arc length and tangential angle.

In one embodiment, defined area 302 may be designed using control board software 362 by assigning coordinates using a Cartesian coordinate system. To map each location of the reference nodes to a distinct place in the natural environment, a two or three-dimensional grid is used. The directions may be X and Y and Z. However, control board software 362 is not limited to the Cartesian coordinate system. Other methods and systems may be used in association with control board software 362, main control board 344, the listed set of reference nodes, and blind node 304 for determining the relative position of blind node 304 with respect to the listed set of reference nodes located in defined area 302.

Data processing system 354 may be a computer with all of the accompanying associated devices and functions that one of ordinary skill in the art would recognize. Data processing system 354 may operate utilizing, without limitation, the listed components of data processing system 200 of FIG. 2. Data processing system 354 hosts software programs such as control board software 362 and location software 356. In another embodiment, data processing system 354 may be another programmable apparatus other than a computer and may be coupled to an associated device of light source 372 in such a way to replicate all of the functions and/or steps in conjunction with the illustrative embodiments.

Location software 356 may be included as a kit, or may be provided as a separate component. Location software 356 is located on data processing system 354. Location software 356 includes visible grid 358. Visible grid 358 is part of a software package that allows a user to visually see the reference nodes in relation to the blind node, which allows communication of the coordinates of the blind node to an associated device of light source 372. Visible grid 358 may display defined area 302 and all of the listed set of reference nodes and blind nodes utilized, such as blind node 304, as a graphical user interface. User interface 364 includes input/output devices, such as computer monitors and keyboards, and positioning data processing tools, such as a computer mouse.

In one embodiment, to determine a current position of a blind node, location software 356 sends a signal through location dongle 350 on main control board 344 to perform a position determination. In this embodiment, blind node 304 determines and calculates its own position. However, in other embodiments, location software 356 may receive all reference node coordinates, such as reference node coordinates 332, and signal strength indicator 334, and the calculation of the location of blind node 304 may be performed by location software 356.

However, in the embodiment, whereby blind node 304 detects its own position in relation to the listed set of reference nodes, a signal from blind node 304 is transmitted to each reference node. Blind node 304 waits for a response signal from each reference node. The signals are transmitted across the low-rate wireless network using a specific wireless standard. In some embodiments, the response signal is used to “wake up” each reference node. Each reference node conserves power by only utilizing power as needed to respond to certain signals from blind node 304, and essentially, reducing power or “going to sleep” when not being used. In one embodiment, blind node 304 and the listed set of reference nodes 308, 310, 312, and 314 are battery-powered devices. Thus, the listed set of reference nodes and blind node 304 utilize minimum power. However, blind node 304 and the listed set of reference nodes 308, 310, 312, and 314 may utilize multiple sources of power to operate according to various models for the nodes.

Once a first signal is sent from blind node 304 to the listed set of reference nodes 308, 310, 312, and 314, a second signal is sent from blind node 304 to the listed set of reference nodes. The second signal requests certain information from each reference node. The second signal requests the set of coordinates for each reference node and further requests signal strength indicator from each reference node.

Signal strength indicator 334 represents signal strength indicator values that may be requested in terms of relative received signal strength indication (RSSI). In wireless environments, relative received signal strength indication is the relative received signal strength. RSSI values are provided from each of the listed reference nodes to blind node 304, upon request, including listed reference nodes 308, 310, 312, and 314.

The RSSI values are often provided in terms of milliWatts (mW) or decibels (dB) of the referenced power to one milliWatt. The watt is a unit of power, equal to one joule of energy per second. The watt as a unit includes a distance component over time. The RSSI values may be used to provide distance to blind node 304. RSSI values are important in determining the location estimation of blind node 304. RSSI values will decrease with increasing distance to blind node 304 from a reference node. The RSSI value is utilized by blind node 304, in addition to reference node coordinates 332 to determine the position of tracked object 306.

The reference nodes receive the signals transmitted for the request. The reference nodes then provide packets to blind node 304 containing the set of coordinates of each reference node, as well as the RSSI value for each reference node. The set of coordinates may be X, Y, and Z coordinates using the Cartesian coordinate system.

In an embodiment, blind node 304 calculates its own position based on the collected parameters of the coordinates and the RSSI values. Distance 316, distance 318, distance 320, and distance 322 are distances between blind node 304 and each relative reference node. The set of distances are determined by using the collected parameters of the coordinates and the RSSI values. Blind node 304 is then able to determine its current location by determining the set of distances from each reference node.

In one embodiment, the blind node position is determined by approximately three different sets of calls. The sets of calls may be separated as a broadcasting phase, a data-collecting phase, and a position-calculating phase. Location software 356 may be configured to periodically query the entry network to locate the position of blind node 304. A broadcast phase comprises of blind node 304 sending out a signal to detect all reference nodes within a certain range of blind node 304. Thus, only the reference nodes that are within a certain range transmit back to blind node 304 a signal. During the data-collecting phase, blind node 304 sends a request for all reference nodes within a certain range to provide the coordinates of the reference nodes, as well as, a relative signal strength indicator. The reference nodes calculate the relative signal strength indicators and transmit the relative signal strength indicator and coordinates to the blind node. The blind node receives the relative signal strength indicator and coordinates. Blind node 304 utilizes the received requested items, the coordinates and the relative signal strength indicators, to calculate the position of blind node 304.

In one embodiment, blind node 304 uses triangulation to calculate its current position. Triangulation is the process of determining the location of a point by measuring angles to it from known points at either end of a fixed baseline, rather than measuring distances to the point directly. The point can then be fixed as the third point of a triangle with one known side and two known angles. The coordinates and, distance to a point can be found by calculating the length of one side of a triangle, given measurements of angles and sides of the triangle formed by that point, and two other known reference points. In one embodiment, the location of blind node 304 is determined through triangulation by using a series of calculations utilizing the coordinates and the RSSI values provided by three reference nodes. The three reference nodes have fixed positions. The coordinates may be communicated to blind node 304, which utilizes the coordinates to calculate a set of distances of each reference node from the other. The set of distances form the sides of a triangle between three reference nodes. The RSSI value indicates the time taken for a signal from blind node 304 to reach a reference node. Blind node 304 utilizes RSSI to determine distance, by determining the amount of time required before receiving a signal from a reference node and then determining the distance of the reference node from blind node 304. In other embodiments, the calculation of blind node 304 may be performed using a method other than triangulation and utilizing less than three reference nodes.

As previously disclosed, the reference nodes may need to be located within a threshold distance of each other to send signals. Further, blind node 304 may need to be within a threshold distance or predetermined distance of each reference node. The measurements of angles and sides form a triangle that may be utilized to determine the location of blind node 304, and thus tracked object 306. In other embodiments, the calculation of blind node 304 may be performed using a method other than triangulation.

In this embodiment, the determination of the current location of blind node 304 is divided into three steps or phases: the broadcast phase, the data collecting phase, and the position calculating phase. The broadcast phase corresponds when blind node 304 sends the first signal to each reference node. The data collecting phase corresponds to when blind node 304 requests and receives the X, Y, and Z coordinates, and the RSSI values of the reference nodes. The position calculating phase occurs when blind node 304 calculates its position and then transmits to main control board 344.

It is important to note that blind node 304 is not always going to be equidistant from the set of reference nodes in defined area 302. The fact that blind node 304 is going to move around in multiple directions according to the movements of tracked object 306, indicates that the distances between blind node 304 and each reference node will vary. Generally, at least three reference nodes and one blind node, such as blind node 304, should be present for the triangulation calculation, as previously described, to occur. However, the user may add as many reference nodes as desired. However, some automatic positioning systems may impose a maximum number of reference nodes used during the broadcast phase, data collection phase, and position calculating phase.

The benefit of using the wireless technology, as explained herein, ensures greater precision in location of blind node 304 in conjunction with the use of multiple reference nodes, whereby the reference nodes are fixed to a known position.

Blind node 304 requests responses from the set of reference nodes after a specific period of time. The period of time is typically programmable by a user from main control board 344. For example, blind node 304 may request a response every three seconds, or every half-second, or any variation of a time period as specified by the user from main control board 344.

Once the current location of blind node 304 is calculated by blind node 304, the current blind node location is transmitted to wireless main control board 344 through wireless signals 338. Wireless main control board 344 may be manufactured by a variety of companies, organizations, and users. In one embodiment, wireless main control board 344 is located at the same distance from defined area 302 as the maximum distance allowable between the set of listed reference nodes as specified by the design capabilities and technology associated with the reference nodes.

Main control board 344 includes location dongle 350. Location dongle 350 is also an end-device but is configured with different responsibilities than an end device utilized as either a reference node or a blind node.

In one embodiment, location dongle 350, the listed set of reference nodes 308, 310, 312, and 314 and blind node 304 are all interchangeable end devices. The end devices are all the same size and all include programmable chips. Each chip may be programmed to specify whether a particular end device operates as a blind node, such as blind node 304, a reference node, or a location dongle. All of the end devices may include means of transmitting wireless signals, such as through use of an antenna or other means for transmitting wireless signals. A blind node, such as blind node 304, is an end device that is configured to request position requests. Blind node 304 waits for a time period to receive a return signal with the requested information. It is important to note that the time periods between signal transfers of all devices included within location tracking and control system 300 may be determined to occur in units of seconds or less, such as milliseconds or anything smaller.

A blind node, such as blind node 304, then receives location coordinates and RSSI values from the reference nodes. A reference node, such as the listed set of reference nodes, is configured to respond with a set of coordinates, or X, Y, and Z, values that correspond to a physical location of the reference nodes. A reference node may also respond to requests from a location dongle, such as location dongle 350 for the set of reference node coordinates.

Location dongle 350 is used in conjunction with control board software 362 and main control board 344 to configure the set of coordinates for the respective reference nodes. Location dongle 350 is thus an end device capable of configuring and requesting a set of coordinates for all reference nodes in defined area 302 in the form of wireless signals 338. As previously described, blind node 304 performed a calculation of its current location and transmitted the calculation as a set of blind node coordinates in defined area 302. However, in other embodiments, location dongle 350 may request all of the reference node coordinates and RSSI values collected by blind node 304 to be transmitted to location dongle 350. Then, main control board 344 may convert the data transmitted to main control board 344 as wireless signals 338 into data packets 352. In this embodiment, location software 362 would perform the triangulation method or some other calculation method to determine the current location of blind node 304, wherein the calculation produces a set of coordinates corresponding to the blind node 304 location.

Main control board 344 obtains the set of coordinates provided by wireless signals 338. Main control board 344 converts wireless signals 338 into data packets 352 for supplying to data processing system 354.

Data packets 352 may be provided to data processing system 354 in a continuous stream or after a specified period of time. In one embodiment, main control board 344 is connected externally to data processing system 354 via serial port. Power may be provided to main control board 344 through either serial port 346 or power cord 348. However, main control board 344 must be connected to data processing system 354. In another embodiment, main control board 344 is housed internally in data processing system 354.

In one embodiment, location software 356 provides coordinates 360 for blind node 304 to associated device of light source 372 to manipulate control motors 376. In one embodiment, control motors 376 further comprise a coordinate converter. The coordinate converter may translate blind node coordinates 360 to units required by control motors 376. Control motors 376 may receive coordinates 360 wirelessly or through a physical wired connection

Control motors 376 are a set of motors used to control the position of associated device of light source 372. Associated device of light source 372 may be moveable in a multitude of directions, including up, down, left, right, forward, and backwards. In one embodiment, associated device of light source 372 is capable of rotating 360 degrees. Associated device may also be moveable in a three dimensional space along all three dimensions.

Control motors 376 use coordinates 360 to automate associated device of light source 372 so that associated device of light source 372 is manipulated by control motors 376. This allows associated device of light source 372 to produce an action of light output 378 in the direction of blind node 304 and the current location of blind node using an automated process. Thus, one of the benefits of this system includes reducing the amount of human manpower needed to manipulate the position of associated device of light source 372 in relation to blind node 304.

Control motors 376 may include a variety of motors familiar to one of ordinary skill in the art. In a preferred embodiment, control motors 376 includes, but is not limited to, a set of step motors. A step motor is a brushless, synchronous electric motor that can divide a full rotation into a large number of steps. The large number of steps are used to control the position of associated device of light source 372. Control motors 376 may include computer controlled step motors, which are versatile. DC motors may also be utilized, whereby DC motors rotate when voltage is applied to their terminals.

Generally, step motors operate differently from normal DC motors. Step motors, on the other hand, effectively have multiple “toothed” electromagnets arranged around a central gear-shaped piece of iron. The electromagnets are energized by an external control circuit, such as a microcontroller. To make the motor shaft turn, first one electromagnet is given power, which makes the gear's teeth magnetically attracted to the electromagnet's teeth. When the gear's teeth are thus aligned to the first electromagnet, they are slightly offset from the next electromagnet. So when the next electromagnet is turned on and the first is turned off, the gear rotates slightly to align with the next one, and from there the process is repeated. Each of those slight rotations is called a “step,” with an integral number of steps making a full rotation. In that way, the motor can be turned by a precise angle.

In one embodiment, coordinates 360 are converted in control motors 376 into a set of coordinates usable by control motors 376. Accordingly, where control motors 376 utilize angles to manipulate associated device of light source 372, coordinates 360 may be converted from Cartesian coordinates to Polar coordinates.

Polar coordinates indicate a location of a point in a two-dimensional coordinate system in which each point on a plane is determined by an angle and a distance. The Polar coordinate system is especially useful in situations where the relationship between two points is most easily expressed in terms of angles and distance, such as with control motors 376. For Polar coordinates, each point is determined by two Polar coordinates: the radial coordinate and the angular coordinate. The radial coordinate denotes the point's distance from a central point known as the pole (equivalent to the origin in the Cartesian system). The angular coordinate (also known as the polar angle or the azimuth angle, and usually denoted by θ or t) denotes the positive or anticlockwise (counterclockwise) angle required to reach the point from the 0° ray or polar axis (which is equivalent to the positive x-axis in the Cartesian coordinate plane). Thus, Cartesian coordinates may be represented as Polar coordinates, and vice versa.

Each point in the Polar coordinate system can be described with the two Polar coordinates, which are usually called r (the radial coordinate) and θ (the angular coordinate, polar angle, or azimuth angle, sometimes represented as φ or t). The r coordinate represents the radial distance from the pole, and the θ coordinate represents the anticlockwise (counterclockwise) angle from the 0° ray (sometimes called the polar axis), known as the positive x-axis for Cartesian coordinates. One important aspect of the Polar coordinate system, not present in the Cartesian coordinate system, is that a single point can be expressed with an infinite number of different coordinates. This is because any number of multiple revolutions can be made around the central pole without affecting the actual location of the point plotted.

Using control motors 376 and associated device of light source 372 may be moved in a lateral direction and in an elevation direction. Control motors 376 process output coordinates 360 to determine whether a change in coordinates from a previously provided set of coordinates has occurred. Thus, when tracked object 306 remains in place, action of light output 378 is directed to the same place until a change in the location of tracked object 306 occurs. Responsive to a change in location associated with tracked object 306, control motors 376 manipulates associated device of light source 372 in an automatic fashion to move to the most current location of tracked object 306.

Action of light output 378 is specific to a function on associated device of light source 372. In one embodiment, control motors 376 may also be instructed to vary the results of action of light output 378 depending on a number of factors. Factors may produce different strengths and qualities for action of light output 378. The number of factors may include, without limitation, the dimensions of tracked object 306. The term “dimensions”, as used herein, refers to both the height, width, and depth of an item. For example, and without limitation, when action of light output 376 is an output of light from a light source, the output of light may be varied in strength and size according to the size of tracked object 306. Tracked object 306 may be a multitude of sizes. Tracked object 306 may be, without limitation, adults or children, in which case, the dimensions of the output of light required would vary according to the dimensions of the person.

Another consideration may include the distance from associated device of light source 372 to tracked object 306. The number of factors may include other characteristics of associated device of light source 372. For example, if associated device of light source 372 is a video camera, control motors 376 may be manipulated to also zoom in and out of tracked object 306 while recording the movements of tracked object 306 to provide a better focus. Also, control motors 376 may be manipulated to record at varying speeds the movements of tracked object 306 in order to slow down or speed up the movements of tracked object 306.

Associated device of light source 372 has an independent power source. Associated device of light source 372 may be mounted at any range of heights. Associated device of light source 372 may also be mounted on any type of surface through any type of means.

Associated device of light source 372 may stop producing action of light output 378 responsive to a number of indications. In one embodiment, a user may manipulate location software 356 by setting the positioning requests to zero, whereby location software 356 does not request a position determination by blind node 304.

After a period of time, if not utilized to send signals, reference nodes conserve power by going into sleep mode. Blind node 304 may also be decoupled from tracking object 306 and moved out of range, further stopping production of action of light output 378 from associated device light source 442.

Light source 372 may be any source of device that produces light. Light source 372 may be a follow spot, known as a stage light in theater productions. Automated location tracking and control system 300 reduces the need for human users to manually manipulate light source 372 to produce light output 378. This is advantageous in situations where light source 372 is difficult to access and to maneuver.

Microprocessor 366, phase and control boards 370 further process the information of coordinates 360. In one embodiment, coordinates 360 are sent from data processing system 354 to microprocessor 366 via serial port 368. Microprocessor 366 utilizes coordinates 360 acquired from location software 356. Microprocessor 366 is typically coupled to data processing system 354 through serial port 368. In other embodiments, microprocessor 366 may be coupled wirelessly to data processing system 354. Further, microprocessor 366 may be located any distance from data processing system 354, depending on an available connecting means that accommodates the chosen distance. Still further, microprocessor function and or phase and control board function may be incorporated within data processing system 354.

Custom software within microprocessor 366 receives coordinates 360 and transforms the coordinates into input voltages 374 sent to circuit boards associated with control motors 376. Microprocessor 366 contains a sequencer for counting steps to move the associated devices and a stepper driver to split the voltage into appropriate phases for the motors of the associated device. Phase and control boards 370 receive voltage information from microprocessor 366 to determine whether an azimuth or elevation step should occur. Control motors 376 capable of rotation in a 360-degree plane manipulate light output 378. Light source 372 may also be moveable in a three-dimensional plane. In another embodiment, the functions of microprocessor 366, and phase and control boards 370, may be incorporated into control motors 376 in light source 372 that work with control motors 376 to produce light output 378.

With reference to FIG. 4, a block diagram of possible arrangements of reference nodes and blind nodes used within the automated tracking system of FIG. 3, in accordance with an illustrative embodiment of the disclosure is presented. FIG. 4 displays Model A 402 as one possible arrangement of a reference node. Model A 402 does not preclude other possible embodiments. Rather, Model A 402 indicates alternate ways to arrange a set of reference nodes in an area other than the “box” shape as illustrated in defined area 302 of FIG. 3. Model B 420 provides another arrangement for a set of reference nodes.

Reference node 404, reference node 406, reference node 408, reference node 410, reference node 412, and reference node 414 may be implemented as reference nodes 308, 310, 312, and 314 as described in FIG. 3. Blind node 416 and tracked object 418 may be implemented as blind nodes 304 and tracked objects 306 of location tracking and control system 300 of FIG. 3.

Reference node 422, reference node 424, reference node 426, and reference node 428 may also be implemented as reference nodes 308, 310, 312, and 314 of location tracking and control system 300 of FIG. 3. Blind node 432 and tracked object 430 may also be implemented as blind nodes 304 and tracked objects 306 of location tracking and control system 300 of FIG. 3.

A user takes into consideration many factors when arranging a set of reference nodes including characteristics of the environment and technological specifications of the hardware devices utilized. Typical configurations will have at least three reference nodes and a blind node tracked object combination. Additional reference nodes will provide more signal area coverage in the defined area in which the blind node and tracked object are to be located. In another example of a reference node layout, reference nodes may be placed in concentric rings to capture location information as the blind node tracked object combination moves about the defined area.

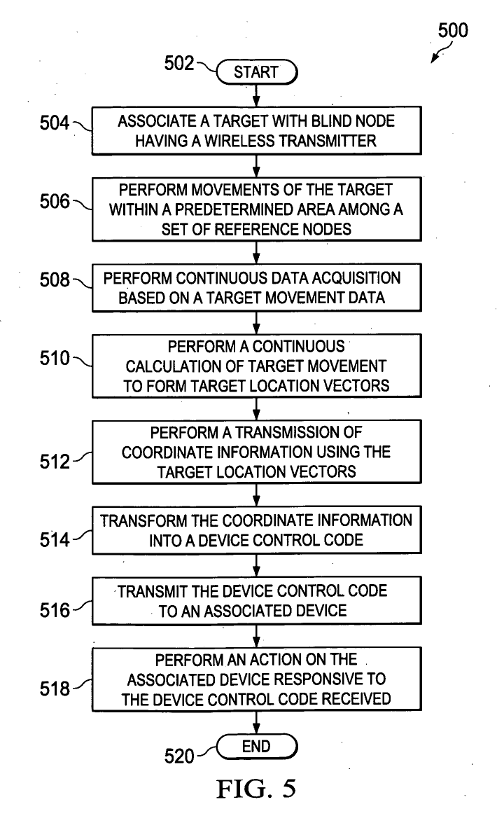

With reference to FIG. 5, a flowchart of an overview of a process using the automated location tracking and control system of FIG. 3 in accordance with illustrative embodiments of the disclosure is presented. Process 500 is an example of a process using the location tracking and control system 300 of FIG. 3.

Process 500 begins (step 502) and associates a target with a blind node wireless transmitter (step 504). A blind node wireless transmitter is typically attached to the object to be tracked in a removable manner. In another example, the blind node wireless transmitter may be formed within or on a surface of the tracked object. In yet another example a blind node wireless transmitter may be loosely attached, for example, by a cable, chain or strap allowing the blind node wireless transmitter to move separately but remain coupled to the tracked object. Process 500 allows the performance of movements of the target within a predefined or predetermined area (step 506). The predetermined area is typically described in a grid manner allowing for coverage of reference nodes within each sector of the grid.

Continuous data acquisition on the target movement is performed (step 508). As the target moves about within the predetermined area location signals are continually broadcast. Using the broadcast data, process 500 performs continuous calculation of target location vectors (step 510). Continuous in this example refers to frequently repeated calculations of the target location using small time increments. The time increments and location changes typically provide for a perceived smooth movement of the target between current and previous positions.

A reference node, a blind node or another intermediary device may perform calculation of the target location. Coordinate information of the target location vectors is sent for further processing when process 500 performs coordinate transmission (step 512). In this operation coordinate information is transmitted to a system, for example, data processing system 354 of FIG. 3 to be processed. Processing typically includes a transform of the coordinate information into a device control code (step 514). A device control code is a signal form recognizable by a target device that is controlled or instructed by the signal form to perform an action.

Process 500 transmits the device control code to an associated device (step 516). The associated device is a device that will perform an action based on the location information based device control code. For example, the device control code created in process 500 may instruct an associated device to change a position to point toward a current location of the target. In this example, process 500 provides instructions to move the associated device in accordance with device control codes received (step 518), with process 500 terminating thereafter (step 520).

With reference to FIG. 6, a flowchart of a detailed location tracking and control process using the automated location tracking and control system of FIG. 3 in accordance with illustrative embodiments of the disclosure is presented. Process 600 is an example of a process using location tracking and control system 300 of FIG. 3.

Process 600 begins (step 602) and a target, such as a blind node associated with a tracked object emits a signal for locating (step 604). A blind node emits a locating signal according to a predetermined interval. In addition reference nodes also emit locating signals. A locator that may be on a reference node or the blind node calculates a location of the target within a defined area at a predetermined interval (step 606). The predetermined interval may be configurable parameter selectable by an operator for each node. A location signal is sent to a receiver (step 608). Sending is performed by one of the set of nodes in the defined area. The receiver acts as a network receiving point for the location signal information sent from the set of nodes. The location signal is received by the receiver (step 610). For example, in location tracking and control system 300 of FIG. 3, wireless network 336 provides a communication system in which a location signal may be sent from the nodes to a receiver such as main control board 344 of FIG. 3.

The location signal is transmitted to a collector (step 612). The collector communicates with the set of nodes through a receiver through the network. The collector parses the received location signal to create current coordinates (step 614). Information contained within the location signal typically contains network control information and other flow and control data that is removed to allow coordinate data to remain.

The current coordinates are transformed from Cartesian coordinates into Polar coordinates (step 616). Cartesian coordinates are provided in the raw location signal and are typically not useful as device control signals. The Polar coordinates are provided to a coordinate processor and saved as previous location coordinates (step 618).

Process 600 determines whether the current coordinates differ from a previous location coordinates (step 620). When a determination is made that the current coordinates differ from a previous location coordinates, a “yes” result is obtained. When a determination is made that the current coordinates do not differ from a previous location coordinates, a “no” result is obtained.

When a “no” result is obtained in step 620, process 600 determines whether to stop action (step 632). When a determination is made to stop action, a “yes” result is obtained. When a determination is made not to stop action, a “no” result is obtained. When a “yes” result is obtained in step 632, process 600 terminates (step 634). When a “no” result is obtained in step 632, process 600 loops back to step 606 to perform the operations as before.

When a “yes” result is obtained in step 620, process 600 sets a location direction based on a difference between the current coordinates of the new location and the previous location coordinates (step 622). Process 600 sends a step command and a count command to a sequencer (step 624). A stepper driver generates and sends a set of voltages corresponding to the commands (step 626). In the illustrated embodiment the sequencer is used to count the number of steps taken and to break the number of steps taken and create four phases to correspond to the number of phases supported by the stepping motors of the associated device. The output of the sequencer in the form of information provided for the four phases is provided as input for the stepper driver. The result is each phase or step taken is partitioned into a percentage of the power required to drive a coil of the stepping motor. The combined use of the sequencer and the stepper driver reduce the coarse grained input coordinate based voltage into fine-grained voltages. The fine-grained voltage provides a smoother transition between steps and therefore movement of the associated device motors.

Receive a set of voltages at an associated device is performed (step 628). Once the voltages have been received at the associated device, apply the received voltages to an associated device actuator to control an action on the associated device as required is performed (step 630). Process 600 determines whether to stop action (step 632) as before.

For example, and without limitation, a table may be created for the associated device movements of left and right where the right movement is a mirror of the left movement. Mirroring is provided by bit shifting of a 1 to the right followed by a zero in the previous position as in 1000, 1100, 0100, 0010, 0011, 0001 is equivalent to a left movement. The bit set in each previous step must be saved for the next step. Inside of the servo motors of the associated device are four coils placed ninety degrees apart at positions of 12, 3, 6, and 9 as if it were a clock. The bit shifting along with saving the previous bit enables the coil to be turned on twice as many steps per single revolution, therefore providing a micro stepping motion that is more readily perceived as a smooth motion. It should be noted that the illustrative embodiments may also be manipulated using other methods besides the method described using the mirroring.

To move a coil or actuator of the associated device, a signal is sent to a single port adjacent to the current port which grounds 2 phases and pushes the coil, in turn moving the servo ½ a step, or 0.9 degrees on the mirror of the associated device. For full movement right or left, bit shift commands of high voltage right or left continue while setting the other two ports to low voltage. For example, sending 1100, 0110, and 0011 will move the light of the associated device to the right and then left by sending 0011, 0110, 1100. The servomotor of the associated device has four coils that drive an axel to the left or right 1.8° with a full rotation of 360°. The circuit and code combination provides twice the number of steps; meaning 0.9° allows 200 steps that span from left to right. For example in an illustrative embodiment, a light of the associated device mounted 8 meters from the front of the reference grid, provides a span of 20 steps from the origin to the right of the grid (3, 0) measured in meters (a span of 18°). Unfortunately, this does not provide precise resolution because the steps can be seen. Using the fine-grained control of the illustrative embodiments provides much better resolution.

In understanding the full functionality of the spotlight in the example of the illustrative embodiment, the 3 by 3 meter grid resolution is 0.25 meter. The axes are then defined as 0, 0.25, 0.5, 0.75, etc. Therefore, each successive coordinate is actually two steps on the servomotor. The program sends 200 steps to the right. The movement to the right is followed by a movement to the left. A reference point is set by sending 113 steps in the left direction. The reference node at position (0, 0) is made to be the reference point. The initial values have to be set to 0 for step calculations to validate the location.

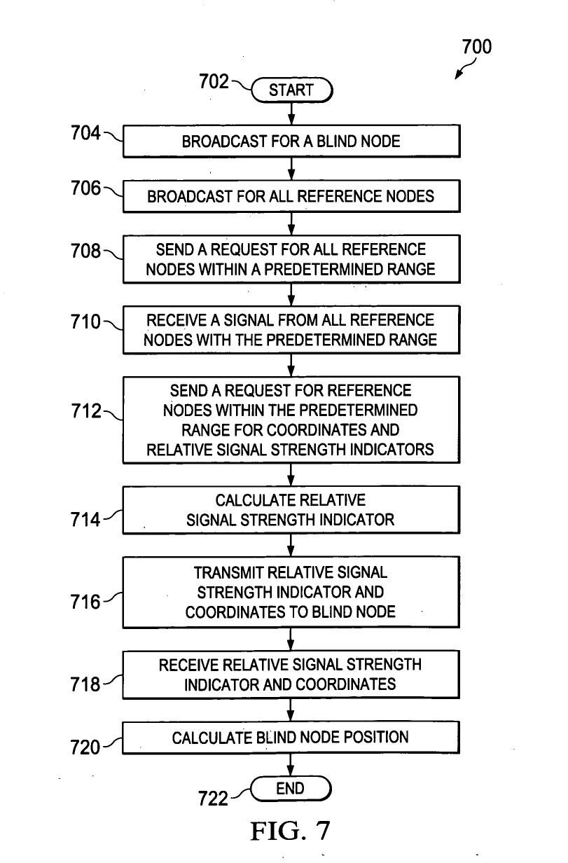

With reference to FIG. 7, a flowchart of a process, used within the location tracking and control process of FIG. 6, for determining a current location of a blind node in accordance with illustrative embodiments of the disclosure is presented. Process 700 is an example of a blind node location process within the context of the location tracking and control process 600 of FIG. 6.

Process 700 may be implemented using the components of location tracking and control system 300 of FIG. 3. FIG. 7 is provided as an example embodiment as a further explanation of the node location process of FIG. 5 and of step 606 in FIG. 6. Process 700 begins (step 702) and broadcasts a signal to alert a blind node to perform a position locating signal step (step 704). Process 700 broadcasts a signal for all reference nodes as well to listen for a signal from a blind node (step 706). A request is sent for all reference nodes within a certain range to respond to the signal from the blind node (step 708). Process 700 receives a signal from all reference nodes within a predefined area (step 710). A request is sent by process 700 for all reference nodes within the predefined area to transmit the respective individual coordinates and relative signal strength indicators (step 712). Responsive to the request, each reference node within range of the blind node and in the predefined area calculates a relative signal strength indicator (step 714). The relative signal strength indicators and reference node coordinates are transmitted from each reference node to the blind node (step 716). The blind node receives the relative signal strength indicator and coordinates (step 718). The blind node utilizes the relative signal strength indicator and coordinates to calculate a current position of the blind node (step 720). Process 700 ends thereafter (step 722).

In another embodiment, process 700 may perform step 606 of FIG. 6 for location calculation of the blind node on a separate node or system, which causes the current blind node position to be transmitted to a main control board using a wireless network. In accordance with one embodiment, the process then continues with the remaining steps as outlined in FIG. 6.

In an illustrative embodiment a computer-implemented process for controlling an associated device utilizing an automated location tracking and control system to produce an action, whereby the process associates a target with a blind node having a wireless transmitter, wherein the target moves within a predetermined area among a set of reference nodes. The computer-implemented process performs a continuous data acquisition based on a target movement data, wherein the continuous data acquisition is repeated within a predetermined interval, performs a continuous calculation of a target location using the target movement to form target location vectors, wherein the continuous calculation is repeated within the predetermined interval, performs a transmission of current coordinate information using the target location vectors, and transforms received current coordinate information into a device control code, wherein the device control code is a set of voltages. The computer-implemented process transmits the device control code to an associated device, and responsive to the device control code, controls an action on the associated device in real time, wherein the action is directed to the tracked object.

The flowchart and block diagrams in the figures illustrate the architecture, functionality, and operation of possible implementations of systems, methods and computer program products according to various embodiments of the illustrative embodiments. In this regard, each block in the flowchart, or block diagrams, may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the illustrative embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the illustrative embodiments has been presented for purposes of illustration and description, but is not intended to be exhaustive or limited to the illustrative embodiments in the form disclosed. Many modifications and variations will be apparent to those of ordinary skill in the art without departing from the scope and spirit of the illustrative embodiments. The embodiment was chosen and described in order to best explain the principles of the illustrative embodiments and the practical application, and to enable others of ordinary skill in the art to understand the illustrative embodiments for various embodiments with various modifications as are suited to the particular use contemplated.

The illustrative embodiments can take the form of an entirely hardware embodiment, an entirely software embodiment or an embodiment containing both hardware and software elements. In a preferred embodiment, the illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments has been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer-implemented process for controlling an associated device utilizing an automated location tracking and control system to produce an action, the computer-implemented process comprising:
associating a target with a blind node having a wireless transmitter, wherein the target moves within a predetermined area among a set of reference nodes;
performing a continuous data acquisition based on a target movement data, wherein the continuous data acquisition is repeated within a predetermined interval;
performing a continuous calculation of a target location using the target movement to form target location vectors, wherein the continuous calculation is repeated within the predetermined interval;
performing a transmission of current coordinate information using the target location vectors;
transforming received current coordinate information into a device control code, wherein the device control code is a set of voltages;
transmitting the device control code to an associated device; and
responsive to the device control code, controlling the action on the associated device in real time, wherein the action is directed to the tracked object.

2. The computer-implemented process of claim 1, wherein the associated device continuously tracks a location of the blind node to produce the action directed to the blind node, wherein the blind node is associated with the target.

3. The computer-implemented process of claim 1, wherein the action produced by the associated device is a light output, recording output, visual output, audio output, or a combination thereof.

4. The computer-implemented process of claim 1, wherein performing a continuous calculation of a target location further comprises:
broadcasting a signal to the blind node and to the set of reference nodes;
sending a request for reference nodes within a predetermined range to transmit individual coordinates and signal strength indicators; and
calculating a current blind node location utilizing the individual coordinates and the signal strength indicators, wherein a triangulation method is used to perform the calculation.

5. The computer-implemented process of claim 1, wherein performing a transmission of current coordinate information further comprises:
parsing the target location vectors to create current coordinates;
transforming the current coordinates from a Cartesian coordinates to a Polar coordinates; and
saving the Polar coordinates as a previous location coordinates.

6. The computer-implemented process of claim 1, wherein transforming received coordinate information into a device control code further comprises:
determining whether the current coordinates differs from a previous location coordinates;
responsive to a determination that the current coordinates differs from a previous location coordinates, setting a location direction based on the difference between the current coordinates and the previous location coordinates;
sending a step command and a count command to a sequencer; and
generating the set of voltages corresponding to the commands.

7. The computer-implemented process of claim 1, wherein transmitting the device control code to an associated device further comprises:
sending the set of voltages to an associated device.

8. The computer-implemented process of claim 6, wherein generating the set of voltages further comprises:
counting a number of steps to be taken;
partitioning the number of steps to be taken into an equal number per phase of the associated device; and
determining a percentage of power to apply to each step of each phase to drive a servo in the associated device.

9. The computer-implemented process of claim 1, wherein controlling an action on the associated device further comprises:
creating a table for different movements of left and right, wherein a right movement is a mirror of a corresponding left movement;
creating an entry in the table wherein the entry is a bit pattern, wherein the bit pattern is processed by bit shifting of a “1” to the right followed by a “0” in a previous position; and
saving a bit set in a previous step for use in a subsequent step enabling a coil within an actuator of an associated device to be turned on twice per number of steps per revolution to realize micro-stepping of the actuator.

10. A computer program product for controlling an associated device utilizing an automated location tracking and control system to produce an action, the computer product comprising a computer recordable-type media containing computer executable program code stored thereon, the computer executable program code comprising:
computer executable program code for associating a target with a blind node having a wireless transmitter, wherein the target moves within a predetermined area among a set of reference nodes;
computer executable program code for performing a continuous data acquisition based on a target movement data, wherein the continuous data acquisition is repeated within a predetermined interval;
computer executable program code for performing a continuous calculation of a target location using the target movement to form target location vectors, wherein the continuous calculation is repeated within the predetermined interval;
computer executable program code for performing a transmission of current coordinate information using the target location vectors;
computer executable program code for transforming received current coordinate information into a device control code, wherein the device control code is a set of voltages;
computer executable program code for transmitting the device control code to an associated device; and
computer executable program code responsive to the device control code, for controlling an action on the associated device in real time, wherein the action is directed to the tracked object.

11. The computer program product of claim 10, wherein the computer executable program code responsive to the device control code, for controlling the action on the associated device in real time, wherein the action is directed to the tracked object further comprises:
computer executable program code for having the associated device continuously track a location of the blind node to produce the action directed to the blind node, wherein the blind node is associated with the target.

12. The computer program product of claim 10, wherein the wherein the action produced by the associated device is a light output, recording output, visual output, audio output, or a combination thereof.

13. The computer program product of claim 10, wherein computer executable program code for performing a continuous calculation of a target location further comprises:
computer executable program code for broadcasting a signal to the blind node and to the set of reference nodes;
computer executable program code for sending a request for reference nodes within a predetermined range to transmit individual coordinates and signal strength indicators; and
computer executable program code for calculating a current blind node location utilizing the individual coordinates and the signal strength indicators, wherein a triangulation method is used to perform the calculation.

14. The computer program product of claim 10, wherein computer executable program code for performing a transmission of current coordinate information further comprises:
computer executable program code for parsing the target location vectors to create current coordinates;
computer executable program code for transforming the current coordinates from a Cartesian coordinates to a Polar coordinates; and
computer executable program code for saving the Polar coordinates as a previous location coordinates.

15. The computer program product of claim 10, wherein computer executable program code for transforming received coordinate information into a device control code further comprises:
computer executable program code for determining whether the current coordinates differs from a previous location coordinates;
computer executable program code responsive to a determination that the current coordinates differs from a previous location coordinates, for setting a location direction based on the difference between the current coordinates and the previous location coordinates;
computer executable program code for sending a step command and a count command to a sequencer; and
computer executable program code for generating the set of voltages corresponding to the commands.

16. The computer program product of claim 10, wherein computer executable program code for transmitting the device control code to an associated device further comprises:
computer executable program code for sending the set of voltages to an associated device.

17. The computer program product of claim 10, wherein computer executable program code for generating the set of voltages further comprises:
computer executable program code for counting a number of steps to be taken;
computer executable program code for partitioning the number of steps to be taken into an equal number per phase of the associated device; and
computer executable program code for determining a percentage of power to apply to each step of each phase to drive a servo in the associated device.

18. The computer program product of claim 10, wherein computer executable program code for controlling an action on the associated device further comprises:
computer executable program code for creating a table for different movements of left and right, wherein a right movement is a mirror of a corresponding left movement;
computer executable program code for creating an entry in the table wherein the entry is a bit pattern, wherein the bit pattern is processed by bit shifting of a “1” to the right followed by a “0” in a previous position; and
computer executable program code for saving a bit set in a previous step for use in a subsequent step enabling a coil within an actuator of an associated device to be turned on twice per number of steps per revolution to realize micro-stepping of the actuator.

19. An apparatus for controlling an associated device utilizing an automated location tracking and control system to produce an action, wherein the apparatus further comprises:
a communications fabric;
a communications unit connected to the communications fabric;
an input/output unit connected to the communications fabric;
a display connected to the communications fabric;
a memory connected to the communications fabric, wherein the memory contains computer executable program code stored therein; and
a processor unit connected to the communications fabric, wherein the processor unit executes the computer executable program code to direct the apparatus to:
associate a target with a blind node having a wireless transmitter, wherein the target moves within a predetermined area among a set of reference nodes;
perform a continuous data acquisition based on a target movement data, wherein the continuous data acquisition is repeated within a predetermined interval;
perform a continuous calculation of a target location using the target movement to form target location vectors, wherein the continuous calculation is repeated within the predetermined interval;
perform a transmission of current coordinate information using the target location vectors;
transform received current coordinate information into a device control code, wherein the device control code is a set of voltages;
transmit the device control code to an associated device; and
responsive to the device control code, control an action on the associated device in real time, wherein the action is directed to the tracked object.

20. The apparatus of claim 19, wherein the processor unit executes the computer executable program code to further direct the apparatus to:
continuously track a location of the blind node to produce the action directed to the blind node, wherein the blind node is associated with the target.

21. The apparatus of claim 19, wherein the action produced by the associated device is a light output, recording output, visual output, audio output, or a combination thereof.

22. The apparatus of claim 19, wherein the processor unit executes the computer executable program code to perform a continuous calculation of a target location further directs the apparatus to:
broadcast a signal to the blind node and to the set of reference nodes;
send a request for reference nodes within a predetermined range to transmit individual coordinates and signal strength indicators; and
calculate a current blind node location utilizing the individual coordinates and the signal strength indicators, wherein a triangulation method is used to perform the calculation.

23. The apparatus of claim 19, wherein the processor unit executes the computer executable program code to perform a transmission of current coordinate information further directs the apparatus to:
parse the target location vectors to create current coordinates;
transform the current coordinates from a Cartesian coordinates to a Polar coordinates; and
save the Polar coordinates as a previous location coordinates.

24. The apparatus of claim 19, wherein the processor unit executes the computer executable program code to transform received coordinate information into a device control code further directs the apparatus to:
determine whether the current coordinates differs from a previous location coordinates;
responsive to a determination that the current coordinates differs from a previous location coordinates, set a location direction based on the difference between the current coordinates and the previous location coordinates;
send a step command and a count command to a sequencer; and
generate the set of voltages corresponding to the commands.

25. The apparatus of claim 19, wherein the processor unit executes the computer executable program code to transmit the device control code to an associated device further directs the apparatus to:
send the set of voltages to an associated device.

26. The apparatus of claim 24, wherein the processor unit executes the computer executable program code to generate the set of voltages further directs the apparatus to:
count a number of steps to be taken;
partition the number of steps to be taken into an equal number per phase of the associated device; and
determine a percentage of power to apply to each step of each phase to drive a servo in the associated device.

27. The apparatus of claim 19, wherein the processor unit executes the computer executable program code to control an action on the associated device further directs the apparatus to:
create a table for different movements of left and right, wherein a right movement is a mirror of a corresponding left movement;
create an entry in the table wherein each entry is a bit pattern formed from a modified previous entry, and wherein the bit pattern is processed by bit shifting of a “1” to the right followed by a “0” in a previous position of the previous entry; and
save a bit set in a previous step for use in a subsequent step enabling a coil within an actuator of an associated device to be turned on twice per number of steps per revolution to realize micro-stepping of the actuator.
